(19) United States
(12) Patent Application Publication
(10) Pub. No.: US 2011/0241413 A1
(43) Pub. Date: Oct. 6, 2011

(54) WHEEL FOR VEHICLE

(76) Inventors: Hiroyuki UCHIDA, Saitama (JP); Mikimasa Matsubayashi, Saitama (JP); Akio Handa, Saitama (JP)

(21) Appl. No.: 13/071,544

(22) Filed: Mar. 25, 2011

(30) Foreign Application Priority Data
Mar. 30, 2010 (JP) 2010-077420

(51) Int. Cl. B60B 3/04; B21D 53/26

(52) U.S. Cl. 301/63.101; 29/894.34

(57) ABSTRACT

A wheel for a vehicle which is excellent in appearance quality, is light, and has stiffness. In the wheel for the vehicle having a rim section which has a substantially cylindrical shape and into which a tire is fit, and a disk section having a substantially disk shape and bonded to the inside of the rim section, the rim section includes a rim body part and a rim flange part, the rim body part is formed such that the thickness of a part to which the disk section is bonded is thicker than the thicknesses of the other parts, and the rim flange part is formed by bending both thin end parts of the rim body part into a hollow shape.

### CROSS-REFERENCE TO RELATED APPLICATIONS

The present application claims priority under 35 USC 119 to Japanese Patent Application No. 2010-077420 filed on Mar. 30, 2010 the entire contents of which are hereby incorporated by reference.

### BACKGROUND OF THE INVENTION

1. Field of the Invention

The present invention relates to a wheel for a vehicle, and in particular, to a two-piece type wheel for a vehicle having a rim section and a disk section.

2. Description of Background Art

In a rim section and a disk section constituting a wheel, high stiffness is required because of use characteristics for a wheel, and in order to secure the stiffness, each of them should have a large thickness, resulting in an increase in the weight. A method of changing the material to an aluminum alloy, a magnesium alloy, etc., having a low specific gravity can be considered; however, the cost becomes high. With respect to this, in the related art, in order to suppress the thickness of the rim section by using steel, a so-called spinning method has been proposed. In the spinning method, a contracting process is performed on a cylindrical workpiece by pressing a roller against the work from the outer circumferential surface toward the inside while rotating the work, so as to form the rim section. See, for example, JP-A No. 2003-2001.

Also, in the related art, in order to ensure stiffness while suppressing the thickness of the rim section, there is known a construction in which a curl configuration is provided at an edge part of the rim section.

However, even though a rim section is manufactured by the spinning method according to the related art, in the case where it is important to ensure stiffness, it is impossible to dramatically decrease the plate thickness. Also, even though the constituent in which the curl is provided according to the related art is employed, in particular, in the case of a material with low plasticity of steel raw materials, since it is easily wrinkled if the thickness decreases, there is a limit in reducing the thickness and thus it is impossible to sufficiently reduce the weight.

### SUMMARY AND OBJECTS OF THE INVENTION

Therefore, an object of an embodiment of the present invention is to provide a wheel for a vehicle which addresses the problems of the technology described above, is excellent in appearance quality, is light weight, and has ensured stiffness.

In order to achieve the object, according to an embodiment of the present invention a wheel (10) for a vehicle is provided having a rim section (11) which has a substantially cylindrical shape and into which a tire (TR) is fit, and a disk section (12) having a substantially disk shape and bonded to the inside of the rim section, wherein the rim section includes a rim body part (15) and a rim flange part (16). The rim body part is formed such that the thickness of a part to which the disk section is bonded is thicker than the thicknesses of the other parts, and the rim flange part is formed by bending both thin end parts of the rim body part into a hollow shape.

According to this configuration, it is possible to form the part to which the disk section particularly requiring stiffness to be bonded thicker than the other ports. Since the rim flange part is formed by bending both the thin end parts of the rim body part in a hollow shape, it is possible to ensure the stiffness and to reduce the weight of the whole wheel.

For example, in the rim section of the wheel, first to fourth taper parts, and a linear part (a drop part) to which a disk section is bonded (welded) are formed, the thickness of the linear part is the largest to ensure the stiffness, the thicknesses of the first taper part and the fourth taper part having diameters larger than the linear part are the smallest, the second taper part connecting the linear part and the first taper part and the third taper part connecting the linear part and the fourth taper part are formed to be gradually thinned toward the first taper part or the fourth taper part. Thinning is performed such that the thickness variation from the linear part to the first taper part or the fourth taper part is gentle, and a hollow bent part (curl part) is formed to ensure the stiffness of the thinned rim flange part.

As a result, a wheel in which in the rim section, the part (linear part) to which the disk section is bonded is thickened to ensure the stiffness, the rim flange part is made thinner than the disk section to achieve a weight reduction. The wheel has a configuration in which a curl part is provided in the hollow bent part at an edge part to ensure the stiffness and to reduce the weight.

Also, in the above-mentioned configuration, the rim flange part may be formed to be rolled inward, and an end (16B) rolled inward may abut on the outer circumferential surface of the rim body part.

According to this configuration, when the rim flange part receives a force from the ground through a tire, since an end rolled inward abuts on the outer circumferential surface of the rim body part so as to receive the force, it is possible to further improve the stiffness.

Further, the rim body part may include intermediate parts (42, 42X, 44, 44X) connected to the rim flange part, and the intermediate part may be gradually thinned toward the rim flange part.

According to this configuration, since the thickness gradually varies, it becomes possible to suppress stress concentration with respect to the flexure of the rim body part caused by the reaction force from a road surface exerted to the rim body part through the tire.

Furthermore, a warped part (16C) facing the inside of the wheel in the axial direction may be formed at a finish end part of the rim flange part.

According to this configuration, when the rim flange part receives the force from the road surface through the tire, since the fore end part of the rim flange part is not rolled toward the inside of the bent part, it is possible to improve the stiffness.

Furthermore, the rim body part may be shaped by a spinning method for shaping a rotating cylindrical member into a predetermined shape by contracting the cylindrical member by pressing the cylindrical member with a spatula, and the rim body part may be formed to be thickened from a part of the cylindrical member which becomes the part connected to the rim flange part toward a part of the cylindrical member to which the disk section is bonded.

According to this configuration, like the case of the spinning process according to the related art, when the rim body part is shaped by the spinning process, the thickness is determined according to the shape of the compact of the rim body part. However, by this method it becomes possible to control the thickness of a desired position, that is, the part to which the disk section requiring the stiffness is bonded.

Furthermore, the rim section may be shaped by a spinning method which shapes a rotating cylindrical member (W) into a predetermined shape by contracting the cylindrical member by pressing the cylindrical member with a spatula, and may be shaped by a first process for moving the spatula toward the other end side along an axial direction while pressing the spatula against the cylindrical member toward a central axis side, a second process for shaping a bulged part (46) bulged toward the outside in a radial direction in a part of the cylindrical member to which the disk section is bonded by stopping the movement of the spatula and separating the spatula from the cylindrical member when the spatula reaches a specific part of the cylindrical member, and a third process for thickening the part to which the disk section is bonded by compressing the bulged part by moving the spatula along the axial direction while pressing the spatula against the cylindrical member toward a central axis side.

According to this configuration, unlike the case of the spinning process according to the related art, it is possible by this method to remove a disadvantage in which the thickness is determined according to the shape of the compact of the rim body part when the rim body part shaped by the spinning process is removed, and control the thickness of a desired position, that is, the part to which the disk section requiring the stiffness is bonded.

Furthermore, the rim flange part warped in the hollow shape may be formed by performing a bending process (Step S7) for bending both thin end parts of the rim body part, and repeating an ironing process for ironing both the bent end parts, and a warping process for warping both the end parts in a direction opposite to the bending direction by squeezing both the end parts (Step S8).

According to this configuration, even when the rim flange part bent in a hollow shape is formed, it is possible to form the rim flange part having improved appearance quality by suppressing the generation of bucking wrinkles.

Furthermore, the rim flange part warped in the hollow shape may be formed by performing a bending process (Step S7) for bending both thin end parts of the rim body part, and repeating an ironing process for ironing both the bent end parts with a mold, and a warping process for warping the rim flange part in a direction opposite to the bending direction by the plasticity of the rim flange part by stopping the ironing using the mold (Step S8).

According to this configuration, even when the rim flange part bent in a hollow shape is formed, it is possible to form the rim flange part having improved appearance quality by suppressing generation of the bucking wrinkles.

Furthermore, drainage holes (16D) may be provided in the bent part of the rim flange part on the inside of the wheel by a press process.

According to this configuration, it is possible to avoid an interference with the tire and form the drainage holes without damaging the appearance. Since the drainage holes are formed by a drilling process using the press process, the open end parts of the drainage holes cave in such that the open edge parts of the drainage holes become smooth-edged so as not to damage the tire.

Furthermore, the wheel may be formed of steel material.

According to this configuration, even with a steel material comparatively weightier than aluminum, it is possible to achieve a weight reduction while ensuring the stiffness of the wheel, and it also becomes possible to reduce the cost.

According to an embodiment of the present invention, it is possible to ensure the stiffness and to reduce the weight of the whole wheel.

According to an embodiment of the present invention, the end rolled inward is made to abut on the outer circumferential surface of the rim body part so as to receive the force, since the end rolled inward abuts on the outer circumferential surface of the rim body part so as to receive the force, it is possible to further improve the stiffness.

According to an embodiment of the present invention, since the intermediate part is made to be gradually thinned toward the rim flange part, it is possible to suppress stress concentration with respect to the flexure of the rim body part caused by the reaction force from a road surface exerted to the rim body part through the tire.

According to an embodiment of the present invention, if the warped part is formed, when the rim flange part receives the force from the road surface through the tire, the fore end part of the rim flange part is not rolled toward the inside of the bent part and it is possible to improve the stiffness.

According to an embodiment of the present invention, if the rim body part is formed to be thickened from a part of the cylindrical member which becomes the part connected to the rim flange part toward a part of the cylindrical member to which the disk section is bonded, it is possible to remove the disadvantage in which the thickness is determined according to the shape of the compact of the rim body part, and control the thickness of a desired position, that is, the part to which the disk section requiring the stiffness is bonded.

According to an embodiment of the present invention, when the rim section is shaped by the spinning method which shapes a rotating cylindrical member into a predetermined shape by contracting the cylindrical member by pressing the cylindrical member with a spatula, if the rim section is shaped by the above-mentioned first to third processes, it is possible to remove the disadvantage in which the thickness is determined according to the shape of the compact of the rim body part when the rim body part is shaped by the spinning process, and control the thickness of a desired position, that is, the part to which the disk section requiring the stiffness is bonded.

According to an embodiment of the present invention, if the rim flange part warped in the hollow shape is formed by repeating the ironing process for ironing both the end parts bent by the bending process, and the warping process for warping both the end parts in a direction opposite to the bending direction by squeezing both the end parts, it is possible to form the rim flange part having an improved appearance quality by suppressing generation of bucking wrinkles even when the rim flange part bent in a hollow shape is formed.

According to an embodiment of the present invention, when the rim flange part warped in the hollow shape is formed by performing a bending process for bending both thin end parts of the rim body part, and repeating an ironing process for ironing both the bent end parts with a mold, and a warping process for warping the rim flange part in a direction opposite to the bending direction by the plasticity of the rim flange part by stopping the ironing using the mold, it is possible to form the rim flange part having an improved appearance quality by suppressing the generation of the bucking wrinkles even when the rim flange part bent in a hollow shape is formed.

According to an embodiment of the present invention, if drainage holes are provided in the bent part of the rim flange part on the inside of the wheel by a press process, it is possible to avoid interference with the tire and form the drainage holes without damaging the appearance, and since the open end parts of the drainage holes cave in such that the open edge parts of the drainage holes become smooth-edged so as not to damage the tire.

According to an embodiment of the present invention, since the rim flange part has a wall part, which extends toward a rotation axis of the wheel to be in contact with the tire, at the fore end of the bent part, and the drainage holes are consecutively provided in the wall part, are in the bent part which is not in contact with the tire, and are provided on the inside of the extension direction of the rotation axis, it is possible to reliably drain from the drainage holes, and since the formation positions of the drainage holes are on the inside of an extension direction of the rotation axis in the curved parts, even when the wheel is mounted to the vehicle, it is difficult to perceive the drainage holes from the outside of the vehicle (the outside of the extension direction of the rotation axis of the wheel), thereby improve the appearance of the wheel.

According to an embodiment of the present invention, if the wheel may be formed of steel material, even with a steel material comparatively weightier than aluminum, it is possible to achieve a weight reduction while ensuring the stiffness of the wheel. In addition, it also becomes possible to achieve a reduction in the cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an appearance view of a wheel for a vehicle;

FIG. 2 is an end cross-sectional view of the wheel for the vehicle of FIG. 1 along a line II-II;

FIG. 3 is a view illustrating processes for manufacturing a wheel for a vehicle;

FIG. 4 is a view illustrating a formation position of a drainage hole;

FIG. 5 is a schematic view illustrating a configuration of a spinning process system for forming a rim body part;

FIG. 6 is a schematic cross-sectional view along the axis line OX of the rim section 11 manufactured by a spinning process system 30;

FIG. 7 is a view illustrating a procedure of a spinning process;

FIG. 8 is a view illustrating a first step of a thickening process;

FIG. 9 is a view illustrating a second step of the thickening process;

FIG. 10 is a view illustrating a third step of the thickening process;

FIG. 11 is a cross-sectional view along a line X-X of FIG. 8;

FIG. 12 is a schematic view of a thickness state after the thickening process;

FIG. 13 is a view (first) illustrating a press curl process;

FIG. 14 is a view (second) illustrating the press curl process;

FIG. 15 is a view illustrating a spinning process machine;

FIG. 16 is a view illustrating an ironing process;

FIG. 17 is a view illustrating a warping process;

FIG. 18 is a perspective view of the appearance of a formed rim flange part;

FIG. 19 is a view illustrating results of load point reaction force values (plastic deformation analysis);

FIG. 20 is a view illustrating a wheel having another shape; and

FIG. 21 is an end cross-sectional view illustrating a wheel having a further shape.

### DETAILED DESCRIPTION OF THE PREFERRED EMBODIMENTS

Hereinafter, an embodiment of the present invention will be described with reference to the drawings.

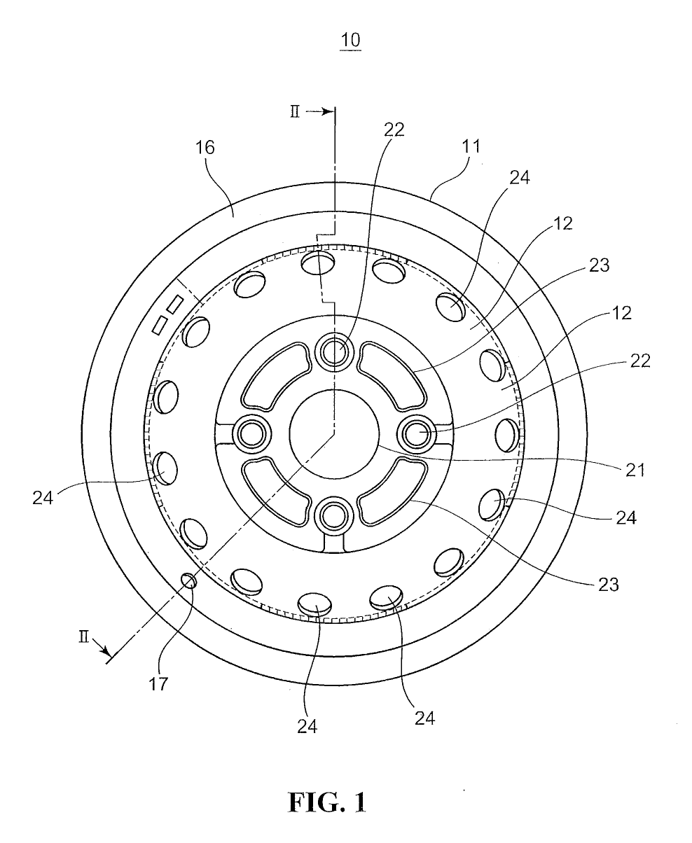

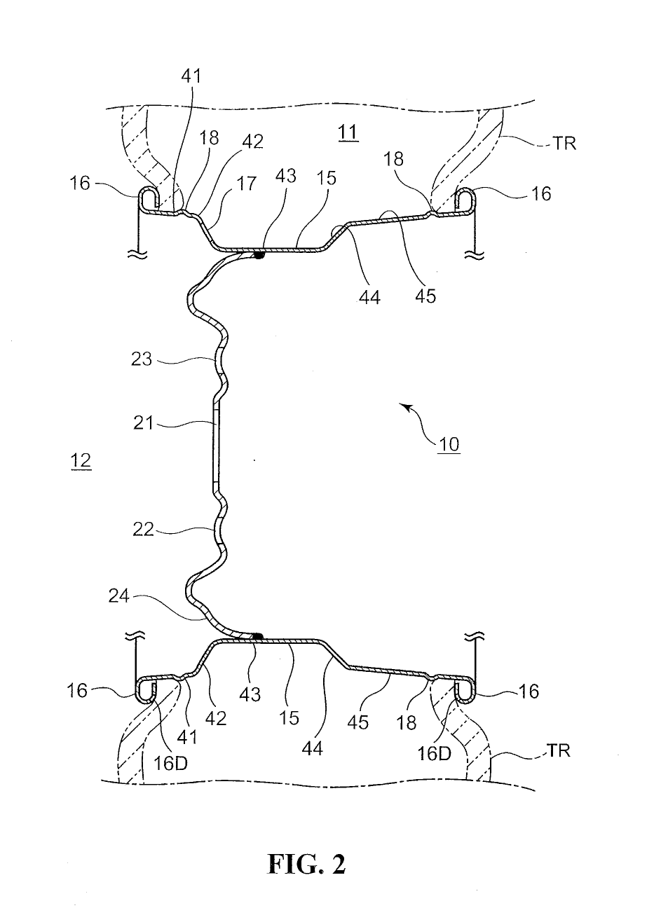

FIG. 1 is an appearance view of a wheel for a vehicle according to an embodiment. FIG. 2 is an end cross-sectional view of the wheel for a vehicle of FIG. 1 along a line II-II.

A wheel 10 for a vehicle generally includes a rim section 11 having a substantially cylindrical shape, and a disk section 12 having a substantially disk shape and bonded to the rim section 11.

The rim section 11 includes a rim body part (a drop part) 15 formed by contracting the peripheral surface of the rim section 11, rim flange parts 16 formed along the peripheral surface of the rim section 11 at both edge parts of the rim section 11, respectively, a valve hole 17 into which an air valve not shown is inserted when a tire TR is mounted, and hump parts 18 for making it difficult for the tire to be stripped off even when the air pressure in the tire TR drops, as shown in FIG. 2.

The disk section 12 includes a hub hole 21 into which a hub of an axle of a vehicle is inserted; a plurality of bolt holes 22 disposed around the hub hole 21 and into which bolts for fixing the wheel 10 to the hub of the axle are inserted; first decorative holes 23 disposed around the hub hole 21 for decoration and formed as openings having a substantially trapezoidal shape to release frictional heat generated in a disk brake provided close to the hub of the axle and take external air for cooling; and second decorative holes 24 disposed near the outer circumference of the disk section 12 for decoration and formed as openings having a substantially cylindrical shape to release frictional heat generated in a disk brake provided close to the hub of the axle and take external air for cooling.

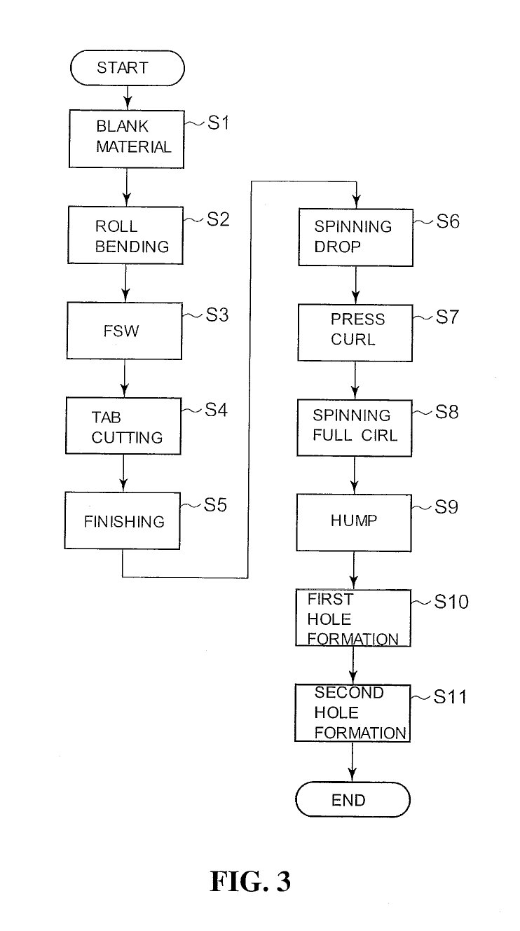

FIG. 3 is a view illustrating processes for manufacturing a steel wheel.

In the case of manufacturing a two-piece type steel wheel, first, a plate-shaped blank material made of steel is prepared (Step S1), and roll bending is performed to roll up the prepared blank material into a cylindrical shape with a roller, etc. (Step S2).

Subsequently, end parts of the rolled blank material in the longitudinal direction are brought into contact with each other, and are joined with each other by, for example, welding (for example, friction stir welding: FSW), thereby manufacturing a cylindrical member.

Then, a tab cut process for cutting an extra part (Step S4) and a finishing process for finishing the cut part (Step S5) are performed.

Next, the rim body part 15 (see FIG. 2) is formed by performing a spinning process on the body of the cylindrical member (Step S6).

After forming the rim body part 15, both end parts of the cylindrical member W are expanded by a press process, and in order to form the rim flange parts 16 (see FIG. 2), a press curl process (Step S7) and a spinning full curl process (Step S8) based on a spinning process are performed. In this embodiment, in forming the rim flange parts 16, a bending process based on the press curl process, and an ironing process and a warping process based on the spinning full curl process are performed. Here, the spinning full curl process is repeatedly performed a plurality of times.

Next, the hump parts 18 are formed in the rim section 11 by a spinning process or a roll forming process (Step S9), drainage holes 16D are formed by performing a press process on the rim flange parts 16 (Step S10), and a valve hole 17 for sealing air to a tire TR mounted on the wheel 10 is formed (Step S11).

In this case, it has become possible to form the drainage holes 16D by the press process since it has become possible to reduce the thickness of the rim flange parts 16. Since the drainage holes 16D are provided at the curved parts of the rim flange parts 16 disposed on the inside of the wheel 10 by the press process, the drainage holes 16D can be formed so as to prevent the interference with the tire TR and so as not to damage the appearance. Further, since the rim flange parts 16 cave in by the press process, the open edge parts of the drainage holes 16D become smooth-edged so as not to damage the tire TR.

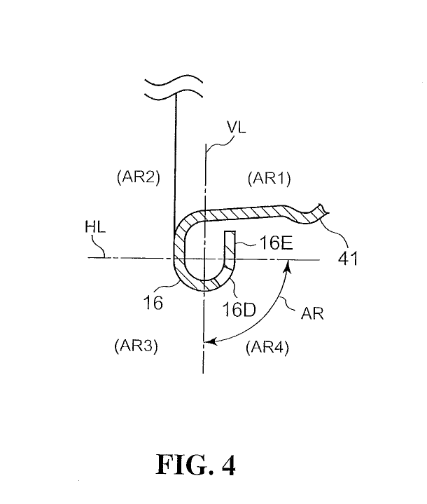

FIG. 4 is a view illustrating a formation position of a drainage hole.

Since the wheel 10 is installed such that the rotational axis becomes horizontal, the ends of the rim flange parts 16 formed to be curved in a hollow shape extend toward the rotational axis of the wheel to be wall parts 16E to be brought into contact with the tire TR, as shown in FIG. 2.

Further, regions obtained by dividing the cross section of a rim flange part 16 into the up side and the down side by a horizontal axis HL on the basis of whether to be contact with the tire TR in a normal state and dividing the cross section of the rim flange part 16 into the left side and the right side by a vertical axis VL at the lowest position of the downward projecting part in the end side of a rim flange part 16 are referred to as regions AR1 to AR4, respectively.

In this case, the drainage holes 16D are consecutively provided in the wall parts 16E, and are provided on the inside of the extension direction of the rotational axis, that is, in the region AR4 in the curved part which is not in contact with the tire TR. Therefore, the drainage holes 16D are not in contact with the tire TR for normal time, it is possible to reliably drain from the drainage holes 16D, and the formation positions of the drainage holes16D are on the inside of an extension direction of the rotation axis of the wheel in the curved parts, it becomes difficult to perceive the drainage holes and the appearance of the wheel is improved.

Next, the formation of the above-mentioned rim body part 15 will be described in detail.

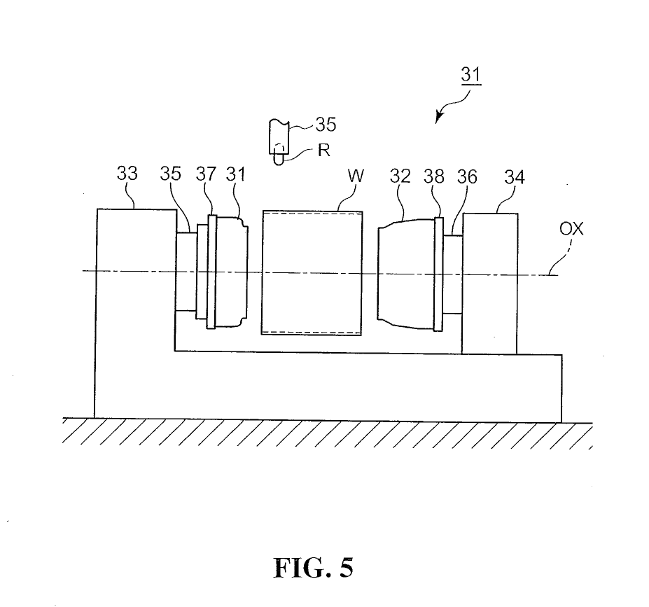

FIG. 5 is a schematic view illustrating a configuration of a spinning process system for forming a rim body part.

The spinning process system 30 includes a first split die 31 and a second split die 32 for holding a cylindrical member W, a rotating device 33 for rotating the cylindrical member W, a compression device 34 for compressing the cylindrical member W, a roller moving device 35 for transferring a roller R, and a control panel not shown for controlling the entire spinning process system 30.

The spinning process system 30 contracts the rim body part 15 formation area of the cylindrical member W by making the roller R abut on the cylindrical member W rotating on a central axis, that is, an axis line OX from the outer circumferential surface of the cylindrical member W, so as to shape the cylindrical member W into a shape according to the outer circumferential surfaces of the first split die 31 and the second split die 32.

The first split die 31 and the second split die 32 are installed such that the rotational axes of the dies are disposed on the same axis line OX.

The outer circumferential surface of the first split die 31 is formed in a shape modeled on the shape of one end side of the rim section 11 of the wheel 10, and the outer circumferential surface of the second split die 32 is formed in a shape modeled on the shape of the other end side of the rim section 11 of the wheel 10. Therefore, one tool modeled on the shape of the wheel rim is formed by bringing the first split die 31 and the second split die 32 in contact with each other.

The first split die 31 is connected to the rotating device 33 through a strut 36 and the second split die 32 is connected to the compression device 34 through the strut 36. In FIG. 5, on the left end side of the first split die 31, a left end flange part 37 with which the left end of the cylindrical member W is brought into contact is formed, and on the right end side of the second split die 32, a right end flange part 38 with which the right end of the cylindrical member W is brought into contact is formed.

The cylindrical member W is fixed in a state in which both ends thereof are in contact with both the flange parts 37 and 38. Also, clamps for fixing both ends of the cylindrical member W may be provided at the first split die 31 and the second split die 32, respectively.

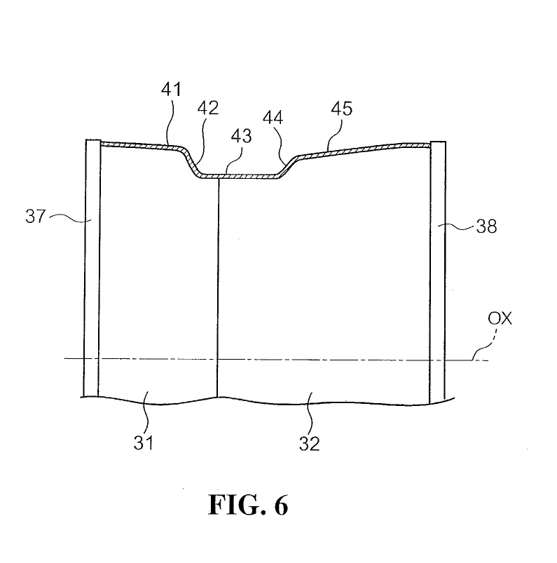

FIG. 6 is a schematic cross-sectional view along the axis line OX of the rim section 11 manufactured by the spinning process system 30.

As shown in FIG. 6, the rim section 11 is formed by shaping the cylindrical member W along the outer circumferential surfaces of the first split die 31 and the second split die 32 which are in contact with each other.

At the substantial center of the rim section 11, a recessed rim body part (drop part) 15 is formed. More specifically, the rim body part 15 is composed of a first taper part 41, a second taper part 42 contracted to have a larger taper angle than the first taper part 41, a linear part 43 extending in parallel with the axis direction, a third taper part 44, and a fourth taper part 45 expanded to have a smaller taper angle than the third taper part 44, in order from the left side to a right side in FIG. 6 when viewed from a cross section along the axis line OX. Among the first taper part 41, the second taper part 42, the third taper part 44, and the fourth taper part 45, the taper angle of the second taper part 42 is the largest.

Therefore, the sharpest acute angle of the rim section 11 is formed between the second taper part 42 and the linear part 43.

Returning to FIG. 5, the rotating device 33 rotates the first split die 31 with the axis line OX as the central axis and rotates the cylindrical member W and the second split die 32 as well.

The roller moving device 35 holds the disk-shaped roller R so that the roller R is rotatable on the central axis substantially parallel with the axis line OX, and performs a spinning process by pressing the roller R against the outer circumferential surface of the cylindrical member W while moving the roller R in a three-dimensional space.

The compression device 34 presses the second split die 32 toward the first split die 31 side along the axis line OX direction with a predetermined thrust. Therefore, in a state in which the cylindrical member W is set on the first split die 31 and the second split die 32, a compression force along the axis line OX direction is exerted to the cylindrical member W.

Next, a detailed procedure of a spinning process in the above-mentioned spinning process system 30 will be described.

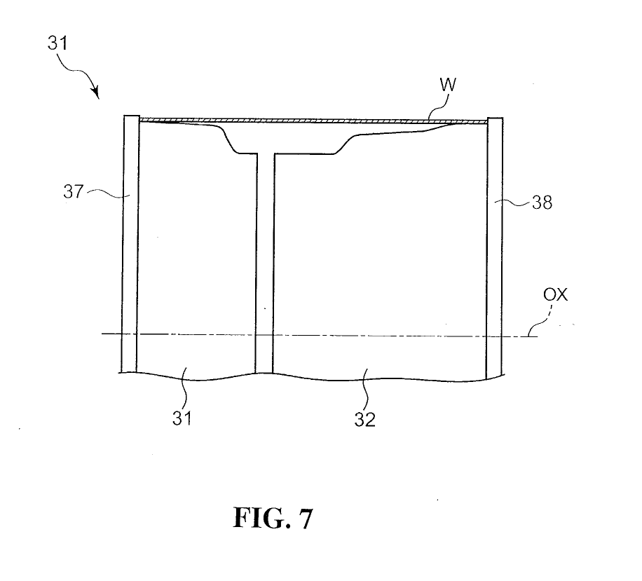

FIG. 7 is a view illustrating a procedure of a spinning process.

First, as shown in FIG. 7, the cylindrical member W is set between the first split die 31 and the second split die 32. More specifically, in FIG. 7, the left end side of the cylindrical member W is brought into contact with the flange part 37 of the first split die 31 and is fixed, and the right end side of the cylindrical member W is brought into contact with the flange part 38 of the second split die 32 and is fixed.

Next, the compression device 34 is driven to drive the second split die 32 to the first split die 31 side along the axis line OX with the predetermined thrust, thereby exerting a predetermined level of compression force to the cylindrical member W from both end sides. Then, the first split die 31 is rotated on the central axis, which is the axis line OX by the rotating device 33, thereby rotating the cylindrical member W while exerting the compression force thereto.

Subsequently, the spinning process is performed by pressing the roller R against the outer circumferential surface of the rotating cylindrical member W, so as to form the rim body part 15.

In the spinning method of this embodiment, a part where a thin part will be generated in the rim body part 15 of the rim section 11 is estimated, and a thickening process for thickening a specific part of the cylindrical member W, on which shaping has not been completed, to be a thin part as a result of the formation is performed in the early stage of the formation.

A detailed procedure of the thickening process will be described below.

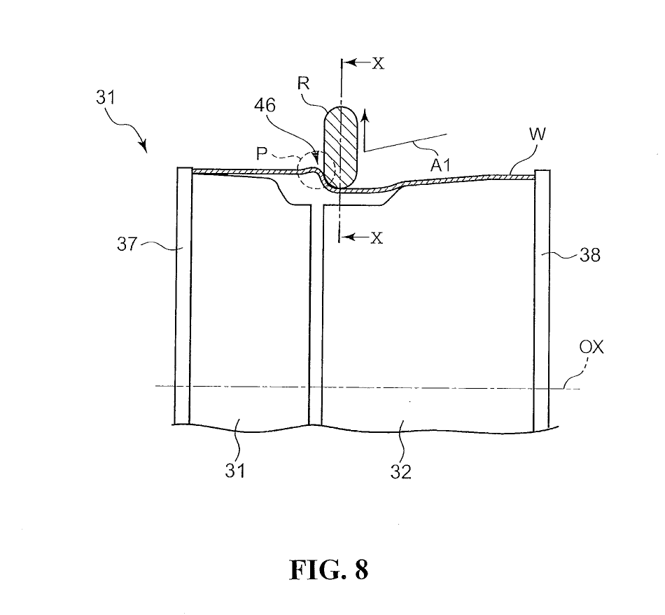

FIG. 8 is a view illustrating a first step of a thickening process.

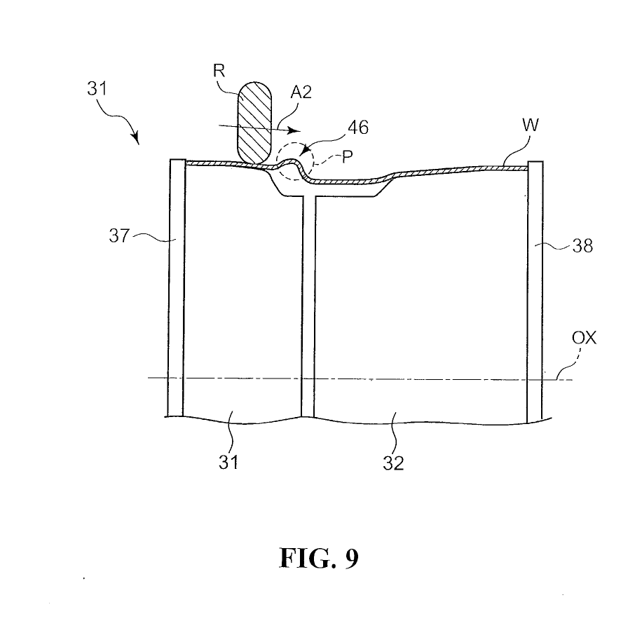

FIG. 9 is a view illustrating a second step of the thickening process.

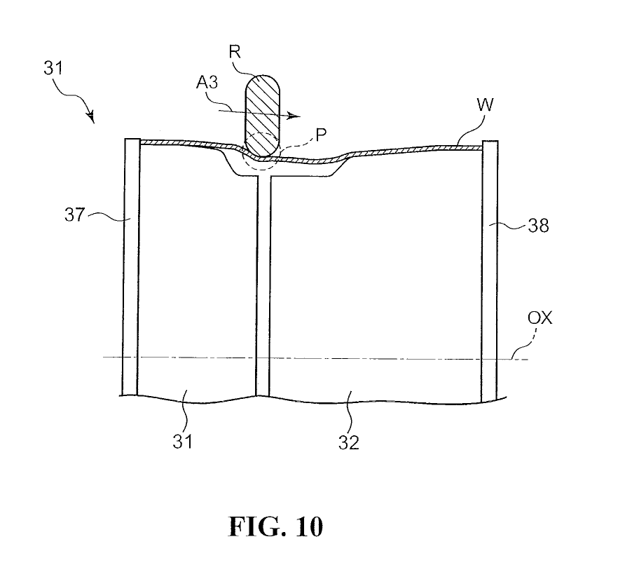

FIG. 10 is a view illustrating a third step of the thickening process.

The thickening process is mainly divided into three steps, that is, a first step, a second step, and a third step. In the first step, as shown before a curve of arrow A1 in FIG. 8, while being pressed against the cylindrical member W from the outer circumferential surface toward the axis line OX side the roller R moves from the formation area of the third taper part 44 toward the second taper part 42 along the axial line OX direction, that is, from the second split die 32 side toward the first split die 31 side.

Next, in the second step, when the roller R reaches the specific part P of the cylindrical member W, the movement of the roller R stops, and as shown after the curve of the arrow A1, the roller R is separated from the cylindrical member W. The specific part P is a part corresponding to an area where a thick part is formed.

In this way, at the specific part P of the cylindrical member W in the early stage of formation, a bulged part 46 bulged toward the radial direction of the cylindrical member W is formed.

Why the bulged part 46 is formed at the specific part P by performing the above-mentioned process in the early stage of formation will now be described.

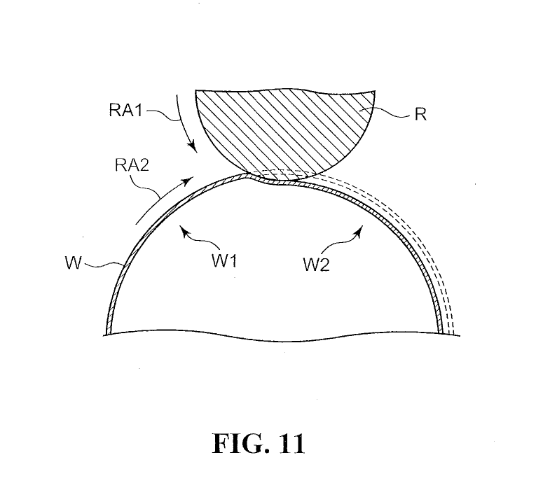

FIG. 11 is a cross-sectional view along a line X-X of FIG. 8.

As shown in FIG. 11, if the roller R is pressed against the rotating cylindrical member W, the roller R rotates along the outer circumferential surface of the cylindrical member W such that the cylindrical member W is gradually contracted.

In this case, in a stage in which the deformation of the cylindrical member W in the radial direction is less, an increase of the material according to the compression of the cylindrical member W is greater than a decrease of the material according to the extension of the cylindrical member W in the axial direction.

Also, since the cylindrical member W is compressed along the axis line OX direction by the first split die 31 and the second split die 32 as described above, the extension along the axis line OX direction is restricted. For this reason, the plate thickness of a part W2 of the cylindrical member W contracted by the roller R becomes larger than the plate thickness of a part W1 of the cylindrical member W having not been contracted by the roller R.

Therefore, if the compression is performed more deeply than a predetermined depth, since it becomes unable to keep up with a change in the volume according to the compression by only the increase of the plate thickness, a perimeter difference occurs in the cylindrical member W. In this case, since the cylindrical member W is compressed along the axial direction and the front side in the progress direction of the roller R is not cured after the process, as shown in FIG. 8, the bulged part 46 is formed at the specific part P.

Next, in the third step, as shown in FIG. 9, while the roller R is pressed against the cylindrical member W toward the axis line OX side, the roller R moves on the bulged part 46 from the first split die 31 side toward the second split die 32 side along the axis line OX direction such that the bulged part 46 is compressed toward the axis line OX side by the roller R as shown in FIG. 10.

As described above, since the compression force along the axis line OX direction is exerted to the cylindrical member W and the extension of the material along the axis line OX direction is restricted, if the bulged part 46 is compressed, the thickness of the specific part P becomes large in proportion to the decrement of the perimeter.

As described above, in the thickness increasing process of this embodiment, expansion is performed by the bulged part 46 such that the perimeter of the specific part P becomes long, and then compression is performed such that the perimeter of the specific part P becomes short, whereby it is possible to thicken the specific part P according to the extension amount of the perimeter.

After the specific part P of the cylindrical member W is thickened by performing the thickening process as described above, the roller R is pressed in a predetermined order to the side of the axis line OX (central axis) of the cylindrical member W so as to shape the cylindrical member W into the shape according to the outer circumferential surfaces of the first split die 31 and the second split die 32. Here, the thickened specific part P is thinned to an extent in shaping into the shapes of the split dies 31 and 32. However, it is possible to make the specific part P thicker than other parts.

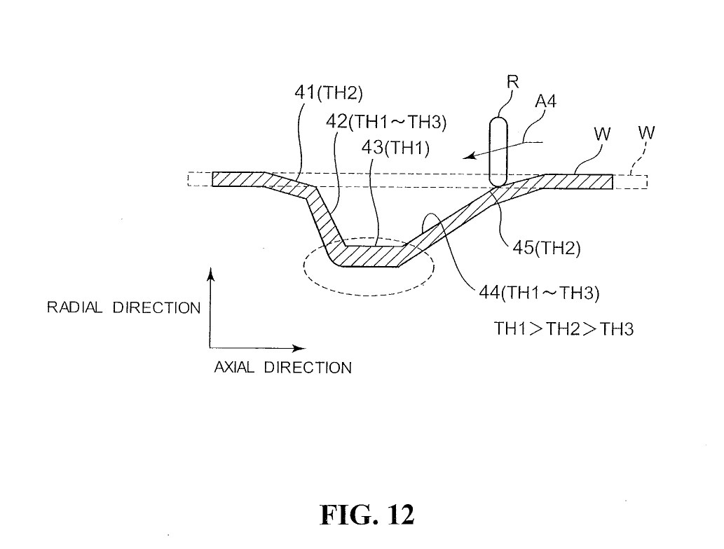

FIG. 12 is a schematic view of a thickness state after the thickening process.

As shown in FIG. 12, it can be seen that when the thicknesses TH2 of the first taper part 41 and the fourth taper part 45 constituting the rim body part 15 are set to the original thickness of a blank member, the thicknesses of the second taper part 42 and the third taper part 44 which are intermediate part connected in series with the linear part 43 which is the rim body part gradually decrease toward the rim flange parts 16 within a range of TH1 to TH3 (TH1>TH2>TH3).

After the formation of the rim body part 15, both the end parts of the cylindrical member W is expanded by a press process, and in order to form the rim flange parts 16 (see FIG. 2), as described above, the press curl process (Step S7) and the spinning full-curl process (Step S8) based on the spinning process are performed.

More specifically, in this embodiment, when the rim flange parts 16 are formed, a bending process based on the press curl process, and an ironing process and a warping process based on the spinning full-curl process are performed.

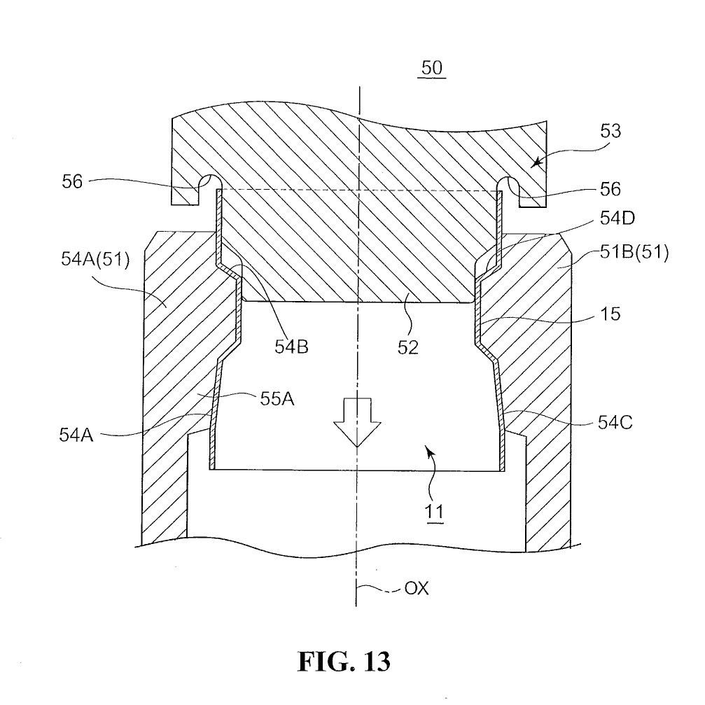

FIG. 13 is a view (first) illustrating a press curl process.

The press curl process (bending process) is performed by a mold press machine 50 shown in FIG. 13.

First, the mold press machine 50 will be described. Note that the peripheral wall of the rim section 11 is formed with a rim body part 15 by the above-mentioned process.

The mold press machine 50 includes a fixed mold 51 and a movable mold 53 provided with a columnar projecting part 52 which is inserted into a semicircular opening of split molds 51A and 51B constituting the fixed mold 51 with the rim section 11 interposed therebetween. In this case, since the mold press machine 50 is for driving the movable mold 53 in a vertical direction, the rim section 11 is installed such that the axis line OX (central axis) extends in the vertical direction in FIG. 13.

In the inner periphery wall of the split molds 51A and 51B, a ring-shaped projecting part 55A with a semicircular arc shape including step parts 54A and 54B, and a ring-shaped projecting part 55B with a semicircular arc shape including step parts 55C and 55D are provided. The rim body part 15 of the rim section 11 is inserted and held between the ring-shaped projecting parts 55A and 55B.

In the movable mold 53 having the columnar projecting part 52 facing the step parts 54B and 54C of the split molds 51A and 51B, a recessed part 56 which is hollow toward the upper side end surface of the fixed mold 51 and has a cross-sectional shape going around in a semicircular arc shape is provided. As described below, the end parts of the rim section 11 are bent to an extent by the recessed part 56.

In the press curl process, as shown in FIG. 13, the rim body part 15 of the rim section 11 is engaged with the ring-shaped projecting parts 55A and 55B of the fixed mold 51, and the sidewall surface of the rim body part 15 on the upper end part side of the rim section 11 is supported by the individual step parts 54B and 54D of the split molds 51A and 51B. Therefore, the upper end part (intended part for forming a curl part) of the rim section 11 in FIG. 13 extends to protrude toward the upper side of the fixed mold 51 and face the movable mold 53.

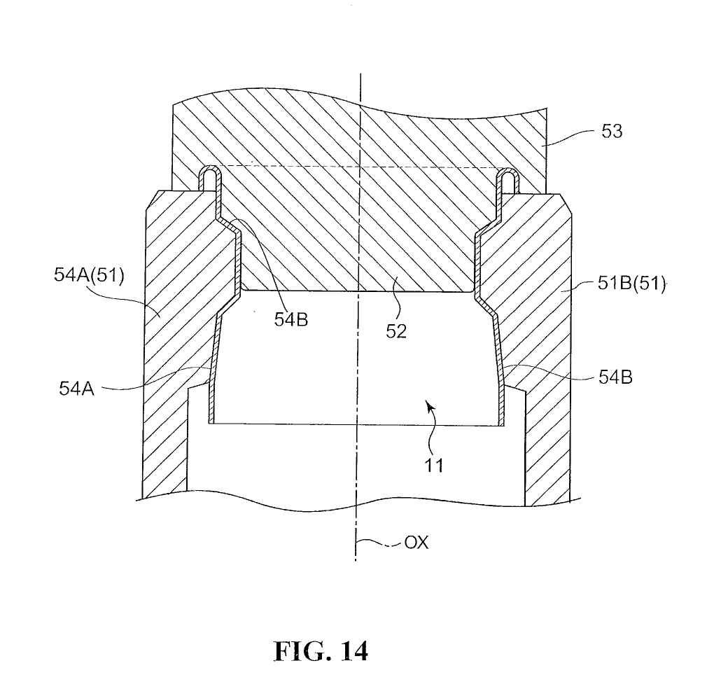

FIG. 14 is a second view illustrating the press curl process.

Next, as shown in FIG. 14, the movable mold 53 moves downward to the fixed mold 51. Therefore, the upper end part of the rim section 11 is formed into a shape corresponding to the recessed part 56 of the movable mold 53. More specifically, a preliminary bending process in which the end part of the rim section 11 is bent to an extent is performed, and as a result, the rim flange parts 16 are formed. Also, during the formation, the lower end part of the rim section 11 is not shaped.

Then, after the movable mold 53 is separated from the fixed mold 51 by moving the movable mold 53 upwardly, the rim section 11 is set in the fixed mold 51 such that the rim section 11 in FIGS. 1 and 3 faces the movable molds not shown joined into the shape of the lower end part side and the rim flange parts 16 are formed at both the end parts of the rim section 11 by performing the same work as the above-mentioned process.

Then, the movable mold 53 moves upwardly so as to be separated from the fixed mold 51, the rim section 11 having the rim flange parts 16 formed at both the end parts in the above-mentioned manner is taken out.

Also, two movable molds may be provided in the up and down directions with respect to the fixed mold 51 to simultaneously form the rim flange parts 16 and 16 with respect to the lower end part and the upper end part of the rim section 11 by the two movable molds.

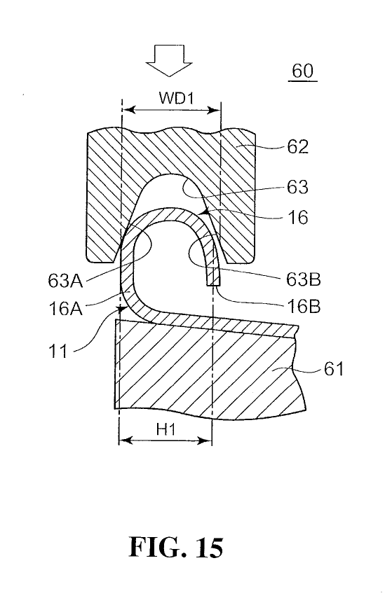

FIG. 15 is a view illustrating a spinning process machine

The rim section 11 taken from the mold press machine 50 is set in a spinning process machine 60 and the ironing process and the warping process based on the spinning full-curl process are performed.

The spinning process machine 60 performing the ironing process and the warping process includes a support mold 61 and a shaping roller 62 as shown in FIG. 15. The support mold 61 has a shape corresponding to the shape of the inner wall of the rim section 11, and is inserted into the rim section 11 so as to support the rim section 11 from the inner wall side.

The shaping roller 62 is formed with a shaping groove 63 going around along the inner wall and is rotatably supported on a support shaft not shown. Further, a bracket not shown holding the support shaft is movable toward the upside, the down side, the left side, the right side, the front side, and the back side in FIG. 15 under an action of a hydraulic cylinder not shown.

Then, the rim section 11 is set in the spinning process machine 60 shown in FIG. 15. That is, the support mold 61 is fit into the rim section 11.

Next, as shown in FIG. 15, the rim flange parts 16 are inserted into the shaping grooves 63 having a substantially V-shaped cross section of the shaping roller 62, and the shaping roller 62 is displaced under an action of the hydraulic cylinder not shown so as to press start end part 16A of the rim flange part 16 with one sidewall 63A. As a result, the start end part 16A becomes substantially flat.

In this way, the rim flange parts 16 can be shaped in stages, thereby capable of distributing stress necessary for shaping of the rim flange parts 16 in stages. As a result, it is possible to process the rim flange parts 16 more accurately.

The dimension WD1 of the shaping groove 64 in the width direction is set to be slightly larger than the dimension H1 of the rim flange parts 16 in the height direction. Thus, the other sidewall 63B facing the sidewall 63A is separated from a finish end part 16B of the rim flange part 16. More specifically, when the start end part 16A is flattened, the finish end part 16B is not shaped.

At this time, in the vicinity of the finish end part 16B of the rim flange parts 16, fine bucking wrinkles are generated.

Therefore, the ironing process (ironing work) is performed in the vicinity of the finish end part 16B, and at the same time, the warping process is performed.

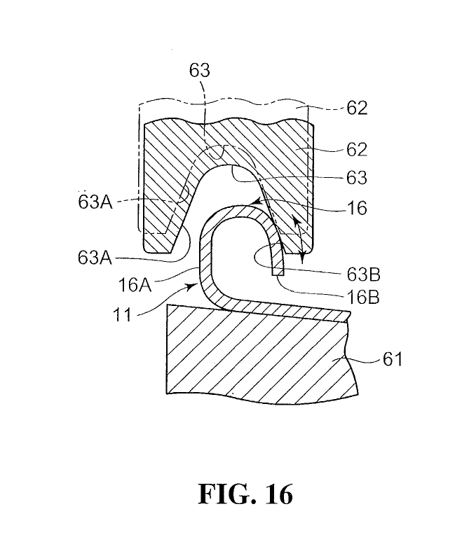

FIG. 16 is a view illustrating an ironing process.

More specifically, as shown in FIG. 16, the shaping roller 62 in which the sidewall 63B of the shaping groove 63 abuts on the vicinity of the finish end part 16B slowly moves to the up side, the down side, the left side, and right side in FIG. 16, thereby gradually extending the vicinity of the finish end part 16B.

The ironing process, that is, a process of extending the vicinity of the finish end part 16B is performed such that the bucking wrinkles extend to be finer. Since the bucking wrinkles are originally fine, it is possible to make a force necessary for extending the bucking wrinkles to be finer small. That is, in this case, it is possible to make a force for removing the bucking wrinkles small. Therefore, since it is possible to adapt a small-sized hydraulic cylinder having a small drive force as the hydraulic cylinder moving the shaping roller 62, it is possible to reduce the size of the spinning process machine 60 and the equipment investment for the spinning process machine 60.

In this embodiment, the ironing process for removing the bucking wrinkles is performed by repeating stopping the shaping roller 62 after slightly moving the shaping roller 62 in a state in which the sidewall 63B of the shaping groove 93 is in point contact with the vicinity of the finish end part 16B of the rim flange part 16 to make it possible to reduce a processing rate. If the ironing process is performed by continuously moving the shaping roller 62 in a state the sidewall 63B is in surface contact with the vicinity of the finish end part 16B of the rim flange part 16, the processing rate of the vicinity of the finish end part 16B of the rim flange part 16 becomes large. For this reason, even though the finish end part 16B is stretched, the bucking wrinkles are not easily removed.

Since the shaping roller 62 moves to the up side, the down side, the left side, and right side, the sidewall 63B of the shaping groove 63 repeats contact (preferably, point contact) and will stop with respect to the vicinity of the finish end part 16B of the rim flange part 16.

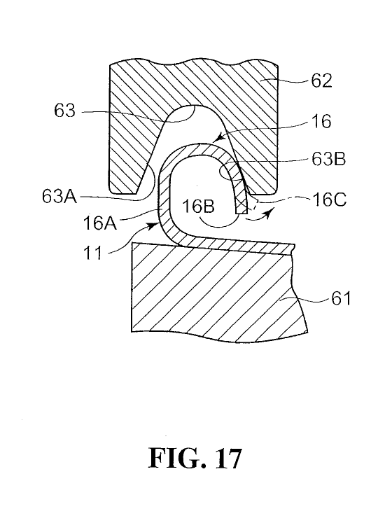

FIG. 17 is a view illustrating a warping process.

When the shaping roller 62 stops, since the rim flange part 16 is not pressed from the shaping roller 62, as shown in FIG. 17, the vicinity of the finish end part 16B of the rim flange part 16 is warped in a direction separated from the peripheral wall of the rim section 11, in order words, a direction returning to the shape before bending by its elasticity. In this way, warping of the rim flange part 16 is performed.

The warping may be performed by separating the sidewall 63B of the shaping groove 63 from the vicinity of the finish end part 16B of the rim flange part 16. For example, the shaping roller 62 may move such that the shaping roller 62 repeats contact (preferably, point contact) and separation with respect to the vicinity of the finish end part 16B.

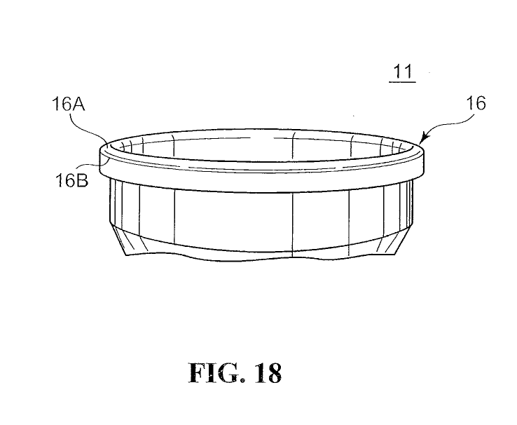

FIG. 18 is a perspective view of the appearance of a formed rim flange part.

The fine bucking wrinkles are gradually stretched and removed by repeating the ironing process and the warping a plurality of times. By moving the shaping roller 62 along the revolving direction of the rim flange part 16 and repeating this work, finally, it is possible to obtain the rim flange part 16 which is excellent in the appearance quality such that bucking wrinkles are rarely perceived as shown in FIG. 18.

Moreover, in this case, since it is unnecessary to make a cut in the rim flange part 16 unlike the related technology, it is possible to ensure the stiffness of the rim flange part 16 and thus the strength of the rim section 11 is not damaged.

More specifically, according to this embodiment, it is possible to easily obtain the rim section 11 having the rim flange part 16 which is excellent in the appearance quality without bucking wrinkles and is excellent in stiffness. Thus, it is possible to obtain a wheel 10 which is light and excellent in stiffness.

Further, since the rim flange part 16 is warped by the warping process, the finish end part 16B is prevented from being warped toward the inside of the rim flange part 16, and when the rim flange part 16 receives a force from the ground through the tire TR, the finish end part 16B of the rim flange part 16 abuts on the peripheral surface of the rim section 11 to receive the force, and it is possible to improve the practical stiffness.

Also, in the warping process, it is also possible to further warp the finish end part 16B of the rim flange part 16 as the warped part 16C so as to prevent the finish end part 16B from being rolled toward the inside of the rim flange part 16.

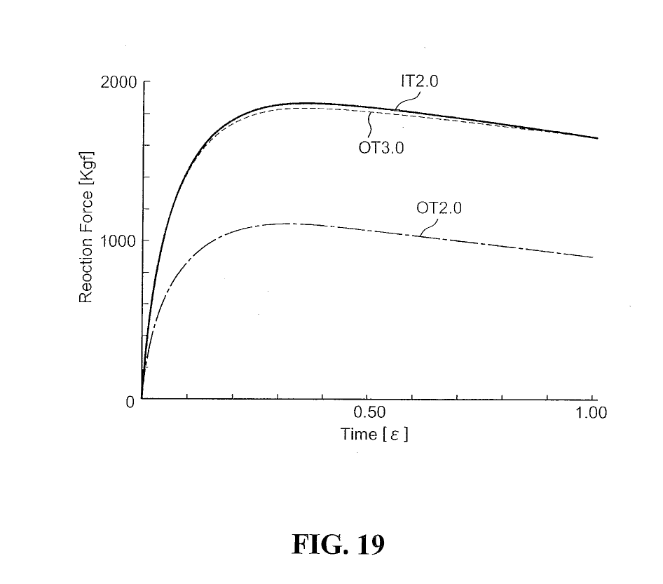

FIG. 19 is a view illustrating results of load point reaction force values (plastic deformation analysis).

As shown in FIG. 19, it can be seen that the load point reaction force value (corresponding to a graph shown by a sign IT2.0 in FIG. 19) of a wheel 10 manufacturing by the processes of this embodiment, wherein the thickness of the blank material is set to 2.0 mm, the rim flange part 16 is formed to be rolled inward and hollow, the end rolled inward abuts on the outer circumferential surface of the rim section 11, and the rim section 11 is formed such that the thickness of a part to which the disk section 12 is bonded (2.5 mm in this example) is larger than the thickness of the other part (2.0 mm in this example), has a value of about 1.8 times as compared to the load point reaction force value (corresponding to a graph shown by a sign OT2.0 in FIG. 19) of a wheel manufactured by a shaping method according to related art in which the thickness of the blank material is set to 2.0 mm likewise and the rim flange part is formed to be rolled outward, and thus the stiffness becomes extremely high.

This can meet a weight reduction requirement and a stiffness acquisition requirement conflicting with each other since the load point reaction force value of a wheel manufactured by the shaping method according to the related art, in which the thickness of the blank material is set to 3.0 mm and the rim flange part is formed to be rolled outward, becomes a value (corresponding to a graph shown by a sign OT3.0 in FIG. 19). Further, a reduction in the cost based on a decrease in the amount of material can be expected.

In this case, the stiffness of the wheel 10 obtained had the same level as the longitudinal stiffness (=100 kgf/mm), the lateral stiffness (=100 kgf/mm), and the tensional stiffness (=100 kgf/mm) in mass-produced wheels.

As described above, according to this embodiment, a wheel in which in the rim section, the bonded part (welded part) of the disk section is thickened to ensure the stiffness, the rim flange part 16 is made thinner than the disk section to achieve weight reduction, and which has a configuration in which a hollow curve part (curl part) is provided at an edge part to ensure the stiffness and reduce the weight, is realized.

More specifically, a wheel having stiffness and light is realized by forming the first taper part 41, the second taper part 42, the third taper part 44, the fourth taper part 45, and the linear part 43 (drop part) to which the disk section 12 is bonded (welded) are formed in the rim section of the wheel, making the linear part the thickest to ensure stiffness, making the first taper part 41 and the fourth taper part 45 having diameters larger than the linear part 43 the thinnest, forming the second taper part 42 connecting the linear part 43 and the first taper part 41 and the third taper part 44 connecting the linear part 43 and the fourth taper part 45 to be gradually thinned toward the first taper part 41 or the fourth taper part 45, performing thinning such that the thickness variation from the linear part 43 to the first taper part 41 or the fourth taper part 45 is smooth, and forming a hollow curve part (curl part) to ensure the stiffness of the thinned rim flange part 16.

In the case where the rim section is manufactured by a spinning method according to the related art, since the thickness is inevitably determined by the processed shape, it is necessary to set the thickness of the rim material in consideration of the thickness of the part to be thinned. However, according to the spinning method of this embodiment, it becomes possible to set the thickness of the rim material more arbitrarily and thus the above-mentioned rim shape first becomes possible.

More particularly, it is possible to arbitrarily ensure the thickness of the recessed corner part of the rim section which is easily thinned.

Also, even in curl formation, in steel having low plasticity, wrinkles are easily generated during curl configuration formation. However, according to the configuration of this embodiment, even with steel, it is possible to realize the above-mentioned rim shape.

As a result, it becomes possible to obtain a wheel in which the part of the rim section to which the disk section is bonded becomes thick to ensure the stiffness and the rim flange part becomes thinner than the disk section to achieve the weight reduction, and which has a configuration in which a hollow curve part is provided at an edge part to ensure the stiffness and reduce the weight.

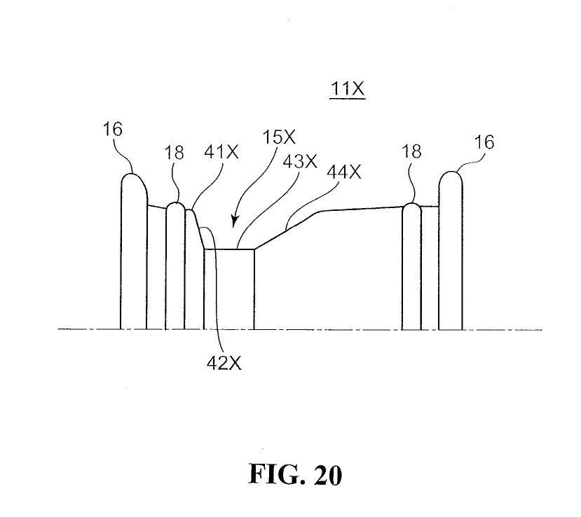

FIG. 20 is a view illustrating a wheel having another shape.

Even though the wheel 10 having the shape shown in FIG. 2 has been described above, as shown in FIG. 20, a wheel 10X including a first taper part 41X, a second taper part 42X contracted to have a larger taper angle than the first taper part 41X, a linear part 43X extending in parallel with the axis direction, a third taper part 44X having a shape gentler than the third taper part 44 of the wheel 10 of FIG. 2, and a fourth taper part 45X expanded to have a smaller taper angle than the third taper part 44X which constitute a rim body part 15X was manufactured by the same processes as the wheel 10. Note that in the disk section not shown, second decorative holes have a round hole shape, similar to the case of FIG. 1.

As a result, the stiffness of the wheel 10X obtained had the longitudinal stiffness (=95 to 105 kgf/mm), the lateral stiffness (=95 to 105 kgf/mm), and the tensional stiffness (=95 to 105 kgf/mm) which are the same levels as the longitudinal stiffness (=100 kgf/mm), the lateral stiffness (=100 kgf/mm), and the tensional stiffness (=100 kgf/mm) in mass-produced wheels.

Also, in the above description, the rim body part is configured to have a plurality of taper parts. However, the rim body part may be configured by disposing a plurality of linear parts in a staircase pattern.

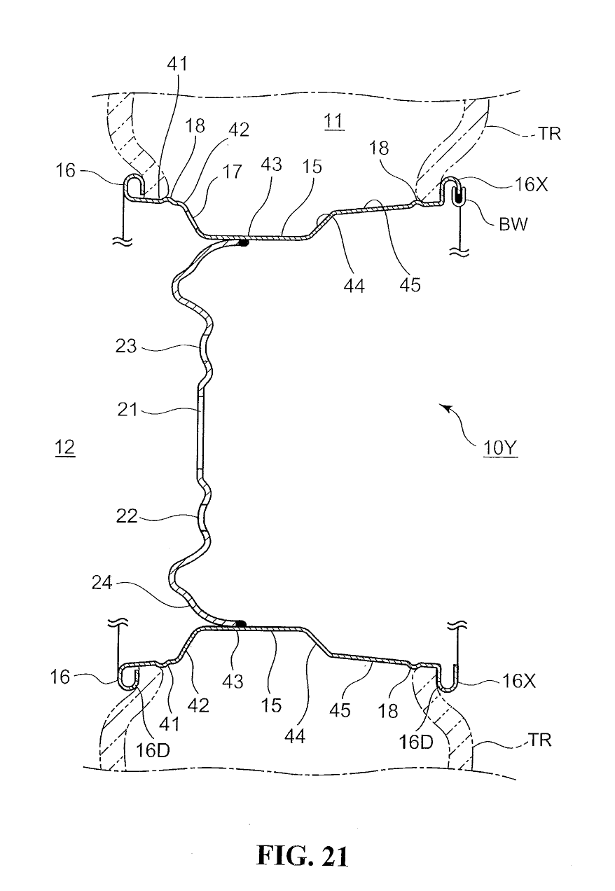

FIG. 21 is an end cross-sectional view illustrating a wheel having a further shape.

In FIG. 21, the same parts as FIG. 2 are denoted by the same signs.

A wheel 10Y for a vehicle generally includes a rim section 11 having a substantially cylindrical shape, and a disk section 12 having a substantially disk shape bonded to the rim section 11. The rim section 11 includes a rim body part (a drop part) 15 formed by contracting the peripheral surface of the rim section 11, a rim flange part 16 formed to be rounded inward along the peripheral surface of the rim section 11 at one edge part of the rim section 11, a rim flange part 16X formed to be rounded outward along the peripheral surface of the rim section 11 at the other edge part of the rim section 11, a valve hole 17 into which an air valve not shown is inserted when a tire TR is mounted, and hump parts 18 for making it difficult for the tire to be stripped off even when the air pressure in the tire TR drops, as shown in FIG. 21.

According to this modification, in the rim flange part 16X, a clip-shaped wheel balance weight BW can be mounted and thus it becomes possible to easily balance the wheel.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wheel for a vehicle comprising:
a rim section having a substantially cylindrical shape adapted to retain a tire; and
a disk section having a substantially disk shape and bonded to the inside of the rim section,
wherein the rim section includes a rim body part and a rim flange part;
the rim body part is formed such that thickness of a part to which the disk section is bonded is thicker than thicknesses of the other parts; and
the rim flange part is formed by bending both thin end parts of the rim body part into a hollow shape.

2. The wheel for a vehicle according to claim 1, wherein the rim flange part is formed to be rolled inward, and an end rolled inward abuts on an outer circumferential surface of the rim body part.

3. The wheel for a vehicle according to claim 1, wherein the rim body part includes intermediate parts connected to the rim flange part, and the intermediate part is gradually thinned toward the rim flange part.

4. The wheel for a vehicle according to claim 2, wherein the rim body part includes intermediate parts connected to the rim flange part, and the intermediate part is gradually thinned toward the rim flange part.

5. The wheel for a vehicle according to claim 1, wherein a warped part facing the inside of the wheel in an axial direction is formed at a finish end part of the rim flange part.

6. The wheel for a vehicle according to claim 2, wherein a warped part facing the inside of the wheel in an axial direction is formed at a finish end part of the rim flange part.

7. The wheel for a vehicle according to claim 3, wherein a warped part facing the inside of the wheel in an axial direction is formed at a finish end part of the rim flange part.

8. The wheel for a vehicle according to claim 1,
wherein the rim body part is shaped by a spinning method for shaping a rotating cylindrical member into a predetermined shape by contracting the cylindrical member by pressing the cylindrical member with a spatula; and
the rim body part is formed to be thickened from a part of the cylindrical member which becomes the part connected to the rim flange part toward a part of the cylindrical member to which the disk section is bonded.

9. The wheel for a vehicle according to claim 2,
wherein the rim body part is shaped by a spinning method for shaping a rotating cylindrical member into a predetermined shape by contracting the cylindrical member by pressing the cylindrical member with a spatula; and
the rim body part is formed to be thickened from a part of the cylindrical member which becomes the part connected to the rim flange part toward a part of the cylindrical member to which the disk section is bonded.

10. The wheel for a vehicle according to claim 3,
wherein the rim body part is shaped by a spinning method for shaping a rotating cylindrical member into a predetermined shape by contracting the cylindrical member by pressing the cylindrical member with a spatula; and
the rim body part is formed to be thickened from a part of the cylindrical member which becomes the part connected to the rim flange part toward a part of the cylindrical member to which the disk section is bonded.

11. The wheel for a vehicle according to claim 5,
wherein the rim body part is shaped by a spinning method for shaping a rotating cylindrical member into a predetermined shape by contracting the cylindrical member by pressing the cylindrical member with a spatula; and
the rim body part is formed to be thickened from a part of the cylindrical member which becomes the part connected to the rim flange part toward a part of the cylindrical member to which the disk section is bonded.

12. The wheel for a vehicle according to claim 1,
wherein the rim section is shaped by the spinning method which shapes the rotating cylindrical member into a predetermined shape by contracting the cylindrical member by pressing the cylindrical member with the spatula; and
the rim section is shaped by:
a first process for moving the spatula toward the other end side along the axial direction while pressing the spatula against the cylindrical member toward a central axis side;
a second process for shaping a bulged part bulged toward the outside in a radial direction in a part of the cylindrical member to which the disk section is bonded by stopping the movement of the spatula and separating the spatula from the cylindrical member when the spatula reaches a specific part of the cylindrical member; and
a third process for thickening the part of the cylindrical member to which the disk section is bonded by compressing the bulged part by moving the spatula along the axial direction while pressing the spatula against the cylindrical member toward the central axis side.

13. The wheel for a vehicle according to claim 1,
wherein the rim flange part warped in the hollow shape is formed by performing a bending process for bending both thin end parts of the rim body part; and
repeating an ironing process for ironing both the bent end parts, and a warping process for warping both the end parts in a direction opposite to the bending direction by squeezing both the end parts.

14. The wheel for a vehicle according to claim 2,
wherein the rim flange part warped in the hollow shape is formed by performing a bending process for bending both thin end parts of the rim body part; and
repeating an ironing process for ironing both the bent end parts with a mold, and a warping process for warping the rim flange part in a direction opposite to the bending direction by the plasticity of the rim flange part by stopping the ironing using the mold.

15. The wheel for a vehicle according to claim 1,
wherein the rim flange part warped in the hollow shape is formed by performing a bending process for bending both thin end parts of the rim body part; and
repeating an ironing process for ironing both the bent end parts with a mold, and a warping process for warping the rim flange part in a direction opposite to the bending direction by the plasticity of the rim flange part by stopping the ironing using the mold.

16. The wheel for a vehicle according to claim 2,
wherein the rim flange part warped in the hollow shape is formed by performing a bending process for bending both thin end parts of the rim body part; and
repeating an ironing process for ironing both the bent end parts with a mold, and a warping process for warping the rim flange part in a direction opposite to the bending direction by the plasticity of the rim flange part by stopping the ironing using the mold.

17. The wheel for a vehicle according to claim 1, wherein a drainage hole is provided in the bent part of the rim flange part by a press process.

18. The wheel for a vehicle according to claim 2, wherein a drainage hole is provided in the bent part of the rim flange part by a press process.

19. The wheel for a vehicle according to claim 17,
wherein the rim flange part has a wall part, which extends toward a rotation axis of the wheel to be in contact with the tire, at the fore end of the bent part; and
the drainage hole is consecutively provided in the wall part, is in the bent part which is not in contact with the tire, and is provided on the inside of an extension direction of the rotation axis.

20. The wheel for a vehicle according to claim 1, wherein the wheel is formed of steel material.
